(19) United States
(12) Patent Application Publication
(10) Pub. No.: US 2006/0263742 A1
(43) Pub. Date: Nov. 23, 2006

(54) Equalizing device and method of measurement in teeth restorations

(76) Inventor: Gunter Saliger, Bensheim (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/266,481

(22) Filed: Nov. 4, 2005

Related U.S. Application Data
(63) Continuation-in-part of application No. 11/184,914, filed on Jul. 20, 2005.

(30) Foreign Application Priority Data
Jul. 20, 2004 (DE) 10 2004 035 090.6

(51) Int. Cl. A61C 19/04; A61C 8/00

(52) U.S. Cl. 433/72; 433/173

(57) ABSTRACT

An equalizing device for measurement in teeth restoration with an implant inserted in a jawbone or on a mounting piece fastened to a manipulation implant provided in a working model. The equalizing device is provided with an opening circumferentially surrounding the mounting piece whereby contact surfaces are provided extending away from the opening and resting against the gingiva surrounding the tooth restoration.

### BACKGROUND OF THE INVENTION.

The invention relates to the field of prosthetic medical care with dental implants and particularly an equalizing device for measurement in teeth restoration with an implant inserted in a jawbone or on a mounting piece fastened to a manipulation implant provided in a working model.

Prosthetic medical care with dental implants is currently a task that is performed by the dentist together with his dental laboratory. The upper edge of an enossal dental implant lies typically near the top of the jawbone in a flush manner. The upper edge of the implant lies additionally in a region which is regularly flushed by saliva and other body fluids and in which there are glands producing various secretions. It is difficult therefore to keep the implant head dry to such a degree that it can be measured directly in the patient's mouth.

The implant head is usually designed in a manner so that a mechanically highly sound connection is made having little tolerance with an excellent fit and having a good frictional connection relative to the suprastructure or to an abutment. This results in geometric designs of the implant head which are difficult to measure with the required accuracy by means of the traditional intraoral measuring method. This applies especially when the implant head is powdered. The problem is additionally compounded through an uneven powder application.

The implant is surrounded by the gingiva or the bone substance. Both surfaces can be powdered only with great difficulties to a degree so that they can be measured with the traditional intraoral measuring method.

EP 1 062 916 A2 discloses a method for producing a tooth replacement as well as a method for producing a tooth replacement element based on the making of a negative impression of the jaw, which makes possible the placement and measuring of implants for the construction of frameworks with the aid of a working model manufactured thereof. The therein given definitions and descriptions of the basic procedure for the preparation of a measurement or for the subsequent construction and production are completely included in the present application.

The therein described method is based on the fact that a so-called manipulation implant is inserted into a conventional impression and a situation is established on the model thereby as it exists in the mouth of a patient after incorporation of the implant. This clinical situation is measured with the aid of a scanner with the goal to produce an abutment and a suprastructure. An auxiliary element is used for the position determination of the implant.

The work is computerized in this method which the dental technician has to carry out already now according to the state-of-the-art, which means, the intermediate steps to be accomplished are digitalized, such as modeling of the abutment, the framework and the facing, and they are subsequently ground to a finish.

A disadvantage is thereby that the proposed method requires a separation between the activity of the dentist on the patient himself and the activity of the dental technician on a model. Application of the method on the patient himself is not possible.

It is the object of the invention to provide a device and a method with which it will be possible to perform construction and manufacturing of the necessary suprastructures directly on the patient with a CAD/CAM apparatus, as desired, without the assistance of a dental laboratory or a dental technician—or to make the work processes of the dental technician more economical and efficient.

The object is achieved with an equalizing device according to the invention described in claim 1. Claimed is additionally the use of said equalizing device as proposed in claim 7 and the transfer together with a mounting piece as proposed in claim 8.

The equalizing device to measure teeth restorations having an implant inserted in a jaw or a mounting piece fastened to a manipulation implant in a working model is provided with an opening circumferentially surrounding the mounting piece whereby contact surfaces are provided extending away from the opening and resting against the gingiva surrounding the tooth restoration.

It is essential that the contact surfaces of the equalizing device rest against a region of the gingiva that is considered to be a healthy gingiva contour or a desired contour. The contact surfaces must thus cover the region of the actual contact and the region of the mounting piece of the implant

The rim of the opening of the equalizing part is advantageously designed as a seal or a seal is arranged at the opening. Penetration of blood and saliva to the surface of the equalizing device is prevented thereby and accurate measurement is made easier thereby.

The rim of the opening is designed according to a development of the invention is such a manner that sliding of the equalizing device along the mounting piece is made possible and/or rotating of said equalizing device relative to the mounting is made possible as well. The equalizing device is thereby adjustable in its orientation relative to the mounting piece.

A marking is advantageously provided to make possible the determination of orientation of the equalizing device relative to the mounting piece.

The surface facing away from the jaw can have a high backscatter coefficient with a Lambert scattering dispersion in the visible and in the near infrared range of the spectrum for additional improvement of the measurement. The surface may be coated thereby.

Improvements in manipulation can be achieved in a method to measure an implant inserted into a jaw or to measure a manipulation implant of a working model—whereby a mounting piece is positioned and fastened on an implant or on a manipulation implant and whereby the mounting piece reflects the position of the implant in the jaw region—if an equalizing device movably arranged on the mounting piece is adjusted to the level of the gingiva and if the establishment of a three-dimensional data set is accomplished for the construction of the suprastructure with consideration of the equalizing device oriented in such a manner.

The perfected shape of the equalizing device takes then the place of the actual geometry of the area of the implant, which can lie outside the measurement range of the measuring camera.

Improved can be a mounting piece on an implant inserted in a jaw or in a manipulation implant of a working model—whereby the mounting piece has a positioning device and fastening means for the implant, and sections known especially by a CAM system in their structure and/or coding—in that an extension is provided between the positioning device and said sections whereby said extension is of such a length that said equalizing device is brought up to the level of the gingiva of the neighboring teeth.

Measurements can be made within the measuring range of the measuring camera even in case of the defective gingiva at the preparation site whereby the construction of the tooth replacement part or the suprastructure can be fitted to the perfected shape of the gingiva.

An embodiment example of the invention is illustrated in the drawings.

### BRIEF DESCRIPTION OF THE DRAWINGS

FIG. 1 shows a typical preparation site for a tooth restoration together with an equalizing device according to the invention in a sectional view along line A-A of FIG. 2;

FIG. 2 shows an equalizing device 7 according to the invention in a perspective view; and

FIG. 3 shows a typical preparation site for a tooth restoration in a sectional view along line B-B of FIG. 2.

### DETAILED DESCRIPTION OF PREFERRED EMBODIMENT

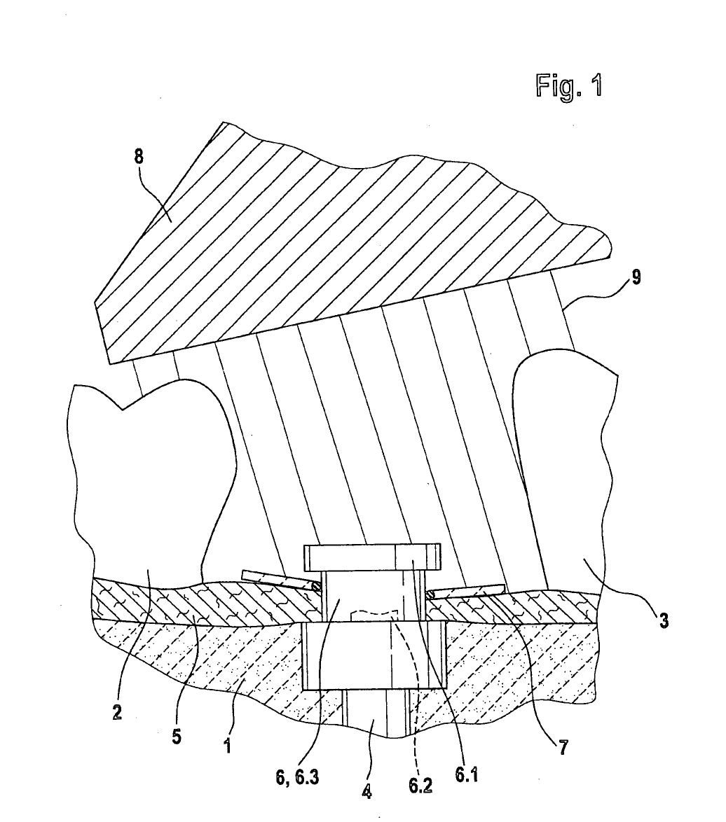

FIG. 1 illustrates a typical preparation site for a tooth restoration. An implant 4 is inserted between the teeth 2, 3 into a jawbone 1 having existing teeth 2, 3. The jawbone 1 is covered with gingiva 5, which is punctured in the area of the implant 4 by a mounting piece 6 connected along a fitting surface lying in between and being a component of a positioning device 6.1.

The fitting surface of the implant is usually designed in a manner so that a good positive fit and a relatively good resistance against twisting is provided whereby the necessary sanitary requirements are considered as well. Various fitting surfaces have been developed historically. The counter-pieces to these surfaces are reproduced and are components of the mounting piece 6.

The mounting piece 6 serves as a slide for an equalizing device 7 surrounding said mounting piece whereby the equalizing device 7 determines and maintains the gingiva level. It is transversely movable along the mounting piece 6 and it can be exchanged after separation from the implant 4. The equalizing piece can be described as a gingiva plate and it is flexibly adjustable in its orientation.

The movable equalizing device 7 is disposed within the depth-of-focus range of an intraoral measuring camera 8 of which only the most forward area is illustrated showing a measuring beam 9 radiating from a measuring aperture. The position and orientation of the equalizing device 7 is obtained from the measured data.

A section 6.1 is provided on the mounting piece 6, which is known to the CAM system in its structure and/or coding and which allows a conclusion about the position and orientation of the implant. With CAM is meant the computer assisted production based on three-dimensional data sets.

The necessary measurement data can also be acquired in a moist and bleeding operation site with the use the so-called gingiva plate.

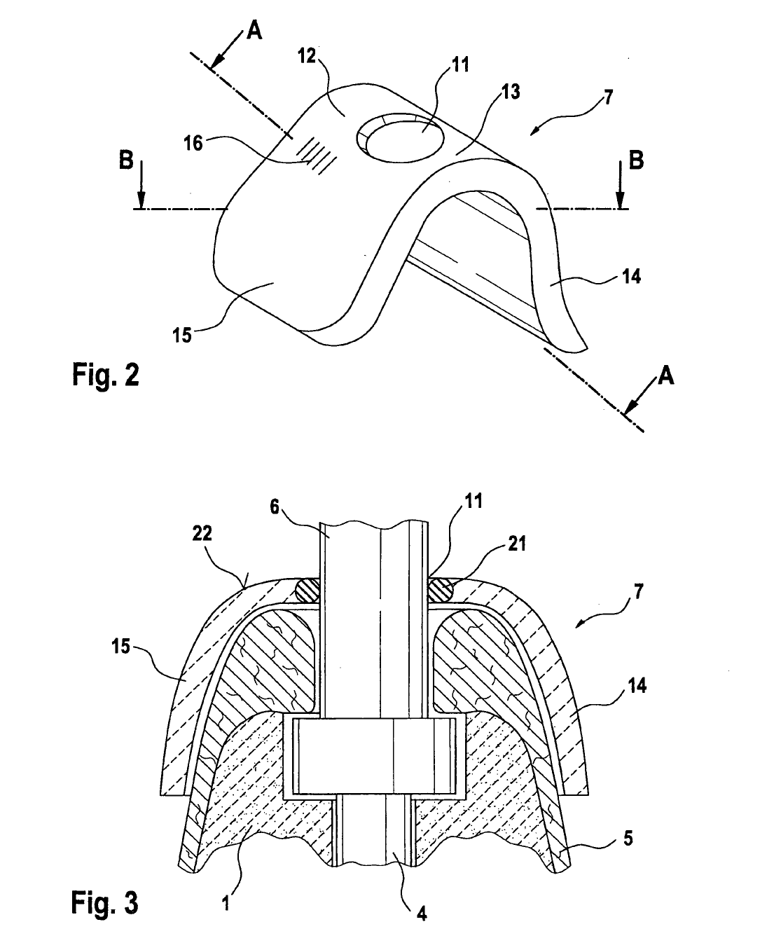

FIG. 2 illustrates an equalizing device 7 in a perspective view showing a saddle shape conforming to the cross section of the jaw. The equalizing device 7 is provided thereby with a center opening 11 and contact surfaces 12, 13 which conform to the cross section of the jaw at least in a nearly tight-fitting manner. The position and orientation of the equalizing device can be detected during measurement.

If the teeth 2, 3 are at a distance apart from the implant 4 to be supplied, then the equalizing part 7 can still be curved in longitudinal direction with consideration of the anatomical conditions of the jaw curvature, which means, it can be curved in the direction of the sectional line AA.

The sides 14, 15 laterally support the equalizing device 7 on the jaw as it can be seen in FIG. 3. However, it is also possible to form the equalizing device like a plate and to perform the fitting to the geometry of the preparation site only through deforming of said plate on location.

Based on the enlarged illustration, it can be seen that in the area of the opening 11 of the equalizing piece 7 a seal 31 is arranged surrounding the mounting piece 26, which prevents blood and saliva from entering the surface 22 of the equalizing piece 7. In conjunction with the CAD/CAM supported production of suprastructures, the mounting piece 6 with its equalizing device 7 is at first fastened to the implant 4 and the equalizing device 7 is subsequently moved up to the level of the gingiva. Measurements and the creation of a three-dimensional data set are performed subsequently. The cervical guide line of an aligned tooth is placed in mesiodistal direction slightly under the gingiva level as established by the equalizing device 7.

This can be performed directly after insertion of the implant in the preparation site or after successful healing as well.

The equalizing piece 7 is advantageously coated with a material having a high backscatter coefficient with a Lambert scattering distribution in the visible and in the near infrared range of the spectrum. Measurement through triangulation according to the principle of a projected grid is made easier thereby.

1. An equalizing device for measurement in teeth restoration with an implant inserted in a jawbone or on a mounting piece fastened to a manipulation implant provided in a working model, wherein said equalizing device includes an opening circumferentially surrounding said mounting piece whereby contact surfaces are provided extending away from the opening and resting against the gingiva surrounding the tooth restoration.

2. An equalizing device according to claim 1, wherein the rim of the opening is designed as a seal or whereby a seal is arranged on said opening.

3. An equalizing device according to claim 1, wherein the rim of the opening is designed is such a manner that sliding of said equalizing device is made possible and/or rotation relative to mounting piece is made possible as well.

4. An equalizing device according to claim 3, wherein a marking is provided making determination of the orientation of the equalizing device possible relative to the mounting piece.

5. An equalizing device according to claim 1, wherein the surface facing away from the jaw can have a high backscatter coefficient with a Lambert scattering dispersion in the visible and in the near infrared range of the spectrum.

6. An equalizing device according to claim 5, wherein the surfaces is coated.

7. A method for measuring an implant inserted into a jaw or to measure a manipulation implant of a working model whereby a mounting piece is positioned and fastened on an implant and whereby the mounting piece reflects the position of the implant in the jaw region, wherein an equalizing device movably arranged on the mounting piece is adjusted to the level of the gingiva and whereby the establishment of a three-dimensional data set is accomplished with consideration of the equalizing device oriented in such a manner.

8. A mounting piece on an implant inserted in a jaw or in a manipulation implant of a working model whereby the mounting piece has a positioning device and fastening means for the implant and it has a section known in its structure and/or coding, wherein an extension is provided between the positioning device and said section whereby said extension is of such a length that said equalizing device according to claim 1 is brought up to the level of the gingiva of the neighboring teeth.
